(19) United States
(12) Patent Application Publication
(10) Pub. No.: US 2009/0023529 A1
(43) Pub. Date: Jan. 22, 2009

(54) Hybrid vehicle drive device

(75) Inventors: Hiroaki Sanji, Anjo (JP); Natsuki Sada, Anjo (JP); Tomoo Atarashi, Anjo (JP); Michitaka Tsuchida, Susono (JP); Hideaki Komada, Gotenba (JP)

Correspondence Address: OLIFF & BERRIDGE, PLC, P.O. BOX 320850, ALEXANDRIA, VA, 22320-4850, US

(73) Assignees: AISIN AW CO., LTD., Anjo-shi (JP); TOYOTA JIDOSHA KABUSHIKI KAISHA, Toyota-shi (JP)

(21) Appl. No.: 12/219,125

(22) Filed: Jul. 16, 2008

(30) Foreign Application Priority Data
Jul. 18, 2007 (JP) 2007-186866

(51) Int. Cl. F16H 37/08

(52) U.S. Cl. 475/5

(57) ABSTRACT

A hybrid vehicle drive device includes an input shaft to which power from an engine is input; an electric generator; an electric motor; a counter gear that transmits power to a drive shaft; a differential gear device that includes a first gear component connected to a rotation shaft of the electric generator, a second gear component connected to the input shaft, and a third gear component connected to the counter gear; and an oil pump that generates hydraulic pressure.

### INCORPORATION BY REFERENCE

The disclosure of Japanese Patent Application No. 2007-186866 filed on Jul. 18, 2007 including the specification, drawings and abstract is incorporated herein by reference in its entirety.

### BACKGROUND

The present invention relates to a hybrid vehicle drive device.

In a drive device of a hybrid vehicle using an engine (internal combustion engine) and an electric motor as a power source, it is necessary to transmit (output) power from two systems to a drive shaft that is connected to a drive wheel via a differential device. Thus, various power train configurations have been developed. This type of drive device includes an oil pump that generates hydraulic pressure for performing lubrication of components of the drive device. In the hybrid vehicle, it is necessary to opt rate the oil pump, even while the hybrid vehicle is running with power output from the electric motor or an operation of the engine is stopped.

Thus, a drive device including an oil pump that can be driven by power from one of an input shaft to which power from the power source is input and an output shaft from which power to be transmitted to a drive wheel is output, has been developed. The drive device includes two one-way clutches which are respectively drive-connected to the input shaft and the output shaft, inside the oil pump, such that the one-way clutch attached to one of the input shaft and the output shaft having greater rotational speed engages with a drive gear of the oil pump. Accordingly, in the drive device, the oil pump is driven by power transmitted to one of the input shaft and the output shaft having greater rotational speed, whereby hydraulic pressure is generated as long as the engine is in operation or the vehicle is moving forward (Japanese Patent Application Publication No. JP-A-10-89446).

### SUMMARY

However, in the drive device described above, there has been a problem in that the shaft direction length of the drive device increases, whereby the drive device increases in size. The reason is that, since the two one-way clutches are arranged to be aligned in the shaft direction and the one-way clutches are provided inside the oil pump in the drive device described above, the shaft direction length of the oil pump included in the drive device increases, whereby the shaft direction length of the drive device increases correspondingly. Also, there has been a problem in that the increase in the size of the oil pump causes an increase in an oil amount within the pump to increase pump loss, whereby the performance of the oil pump decreases.

The present invention provides a hybrid vehicle drive device that can operate an oil pump by power from one of an input side rotation shaft and an output side rotation shaft and which can shorten the shaft direction length of the drive device to achieve a reduction in size without causing the performance of the oil pump to decrease.

A hybrid vehicle drive device according to a first aspect of the present invention includes an input shaft to which power from an engine is input; an electric generator; an electric motor; a counter gear that transmits power to a drive shaft; a differential gear device that includes a first gear component connected to a rotation shaft of the electric generator, a second gear component connected to the input shaft, and a third gear component connected to the counter gear; and an oil pump that generates hydraulic pressure. The oil pump includes an oil pump gear mechanism that generates hydraulic pressure and an oil pump shaft connected to the oil pump gear mechanism; the oil pump shaft is drive-connected to the input shaft via a first one-way clutch and is drive-connected to the counter gear via a second one-way clutch; and the first and second one-way clutches are arranged on an inner circumference side of a bearing of the counter gear such that at least one of the first and second one-way clutches overlaps with the bearing of the counter gear in a shaft direction.

### BRIEF DESCRIPTION OF THE DRAWINGS

Various exemplary aspects of the invention will be described with reference to the drawings wherein:

FIG. 1 is a skeleton view of a drive device according to a first embodiment of the present invention;

FIG. 2 is a sectional view showing a schematic configuration of the drive device according to the first embodiment;

FIG. 3 is an enlarged sectional view of a vicinity of an oil pump;

FIG. 4 is an arrangement view showing arrangement relations among respective shafts included in the drive device according to the first embodiment; and

FIG. 5 is a sectional view showing a schematic configuration of a drive device according to a second embodiment of the present invention.

### DETAILED DESCRIPTION OF EMBODIMENTS

Preferred embodiments of a hybrid vehicle drive device of the present invention will be described below in detail based on the drawings. In the following embodiments, a transverse-type drive device is mounted to a car having a front-engine front-wheel drive (FF) layout.

### First embodiment

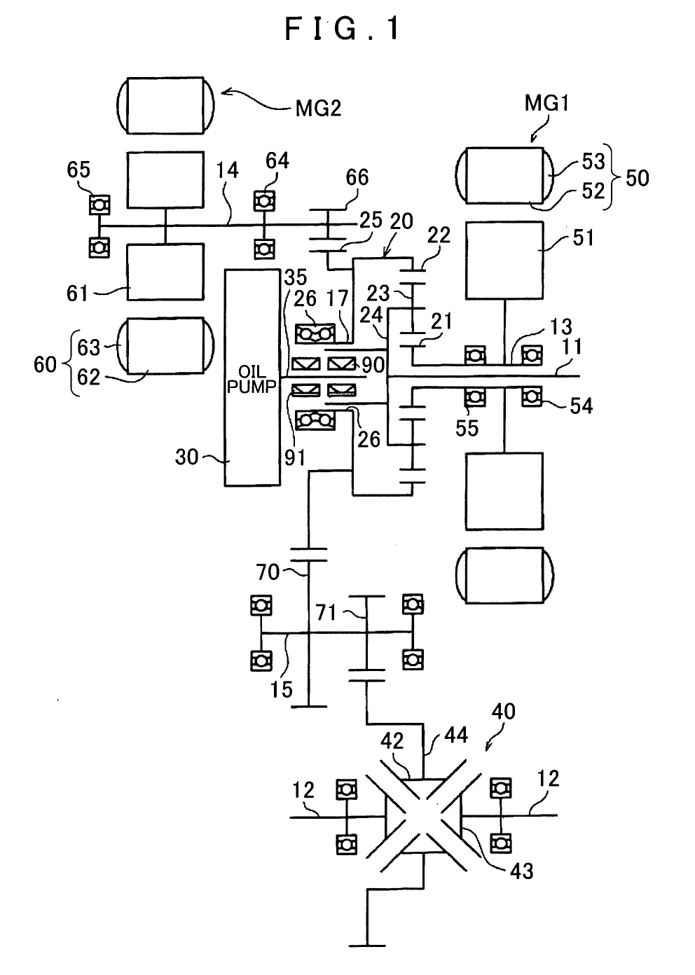

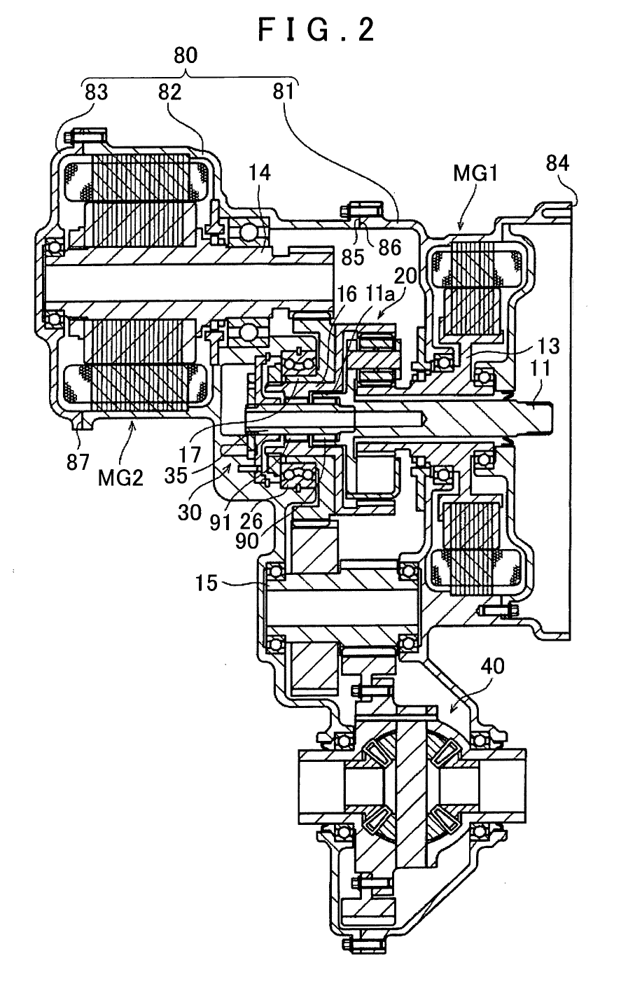

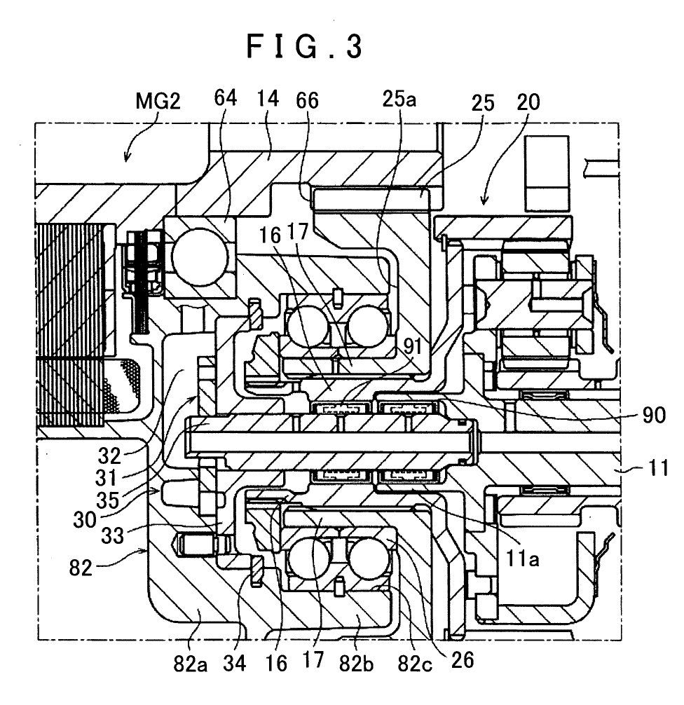

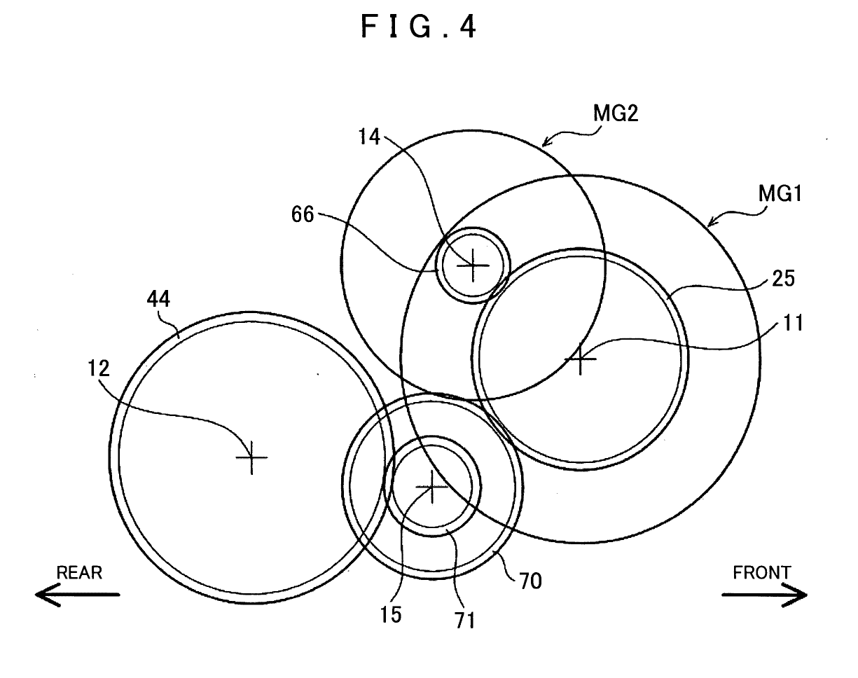

The drive device according to a first embodiment of the present invention is a drive device in which an electric motor is arranged on an axis different from an input shaft. The drive device according to the first embodiment will be described with reference to FIGS. 1 to 4. FIG. 1 is a skeleton view of the drive device according to the first embodiment. FIG. 2 is a sectional view showing a schematic configuration of the drive device according to the first embodiment. FIG. 3 is an enlarged sectional view of a vicinity of an oil pump. FIG. 4 is an arrangement view showing arrangement relations among respective parts included in the drive device according to the first embodiment.

As shown in FIG. 1, the drive device according to the first embodiment includes an input shaft 11 to which power is input from an engine (not shown), a motor generator MG1, a motor generator MG2, a differential gear device 20 to which the motor generator MG1, the motor generator MG2, and the input shaft 11 are connected, an oil pump 30 for generating hydraulic pressure, and a differential device 40 connected to the differential gear device 20. Accordingly, the power from the engine and power from the motor generator MG2 can be transmitted via the differential gear device 20 and the differential device 40 to a drive shaft 12 connected to a drive wheel.

The input shaft 11 is arranged coaxially with a crankshaft (not shown) of the engine, whereby the power from the engine is transmitted to the input shaft 11. The motor generator MG1 is arranged coaxially with the input shaft 11. The motor generator MG1 operates as an electric motor (power running function) that is driven by an electric power supply and as an electric generator (regeneration function) that converts mechanical energy to electric energy. The motor generator MG1 is mainly operated as the electric generator, and is also used as a starter for the engine. As the motor generator MG1, an AC synchronous motor generator may be used, for example. As an electric power supply device which supplies electric power to the motor generator MG1, an electric storage device, such as a battery or capacitor, or a known fuel cell may be used, for example. Note that the motor generator MG1 in this embodiment is an example of an “electric generator” according to an aspect of the present invention.

The motor generator MG1 has a stator 50 secured to a transaxle case 80 described later and a rotatable rotor 51. The stator 50 has a stator core 52 and a coil 53 wound around the stator core 52. The rotor 51 and the stator core 52 are formed by laminating a plurality of magnetic steel sheets, respectively having predetermined thicknesses, in a thickness direction thereof. Note that the plurality of magnetic steel sheets are laminated in the shaft direction of the input shaft 11. A rotor shaft 13 is arranged at the center of the rotor 51, and the rotor 51 and the rotor shaft 13 are connected. Accordingly, the rotor 51 and the rotor shaft 13 rotate integrally. The rotor shaft 13 is a hollow shaft, and has the input shaft 11 arranged therein. The input shaft 11 and the rotor shaft 13 are formed to be capable of relative rotation. Bearings 54 and 55 supporting the rotor shaft 13 are arranged in a space inside the rotor 51. Note that the rotor shaft 13 in this embodiment is an example of a “rotation shaft of the electric generator” according to an aspect of the present invention.

The differential gear device 20 is arranged coaxially with the motor generator MG1, i.e., coaxially with the input shaft 11. The differential gear device 20 is arranged adjacent to the motor generator MG1 in the shaft direction of the input shaft 11. The differential gear device 20 is formed of a planetary gear set having a so-called single pinion configuration. That is, the differential gear device 20 has a sun gear 21, a ring gear 22 arranged coaxially with the sun gear 21, and a planetary carrier 24 holding a planetary pinion gear 23 which meshes with the sun gear 21 and the ring gear 22. The sun gear 21 and the rotor shaft 13 are connected, and the planetary carrier 24 and the input shaft 11 are connected. A counter gear 25 is connected to the ring gear 22. Note that the sun gear 21 of this embodiment is an example of a “first gear component” according to an aspect of the present invention, the planetary carrier 24 is an example of a “second gear component” according to an aspect of the present invention, and the ring gear 22 is an example of a “third gear component” according to an aspect of the present invention.

The oil pump 30 is arranged coaxially with the motor generator MG1 and the differential gear device 20 to be adjacent to the differential gear device 20. The oil pump 30 is a gear pump which generates hydraulic pressure by driving an oil pump gear mechanism (drive gear, driven gear, and crescent) included in a casing. By the hydraulic pressure generated by the oil pump 30, lubrication of respective parts of the drive device (particularly, lubrication inside the differential gear device 20) is performed.

The oil pump 30 includes an oil pump shaft 35 connected to the oil pump gear mechanism. The oil pump shaft 35 is drive-connected with the input shaft 11 via a one-way clutch 90, and is drive-connected with the counter gear 25 via a one-way clutch 91. The one-way clutch 90 of this embodiment is an example of a “first one-way clutch” according to an aspect of the present invention, and the one-way clutch 91 is an example of a “second one-way clutch” according to an aspect of the present invention.

The one-way clutches 90 and 91 are arranged outside the oil pump 30, and are set to transmit one of the rotations of the input shaft 11 and the counter gear 25 having a greater speed in a predetermined rotational direction to the oil pump shaft 35 and set free of the rotation having a slower speed (including a stopped or reversed rotation). Accordingly, rotational power of one of the input shaft 11 and the counter gear 25 is transmitted to the oil pump shaft 35 to operate the oil pump gear mechanism, whereby the hydraulic pressure is generated. Since the one-way clutches 90 and 91 are arranged outside the oil pump 30 (inner circumference of a boss section of the counter gear 25) in this manner, the shaft direction length of the oil pump 30 is shortened compared to that of an oil pump of the related art (having a built-in one-way clutch). Note that the details of the configuration of the oil pump 30 and arrangements of parts therearound are described later.

On the other hand, the motor generator MG2 is arranged on a separate axis parallel to the input shaft 11. The motor generator MG2 is arranged on an opposite side of the motor generator MG1 with respect to the counter gear 25 in the shaft direction. The motor generator MG2 operates as an electric motor (power running function) that is driven by an electric power supply and as an electric generator (regeneration function) that converts mechanical energy to electric energy, in the same manner as the motor generator MG1. The motor generator MG2 mainly operates as the electric motor. As the motor generator MG2, an AC synchronous motor generator may be used, for example. As the electric power supply device, an electric storage device, such as a battery or capacitor, or a known fuel cell may be used, for example. Note that the motor generator MG2 in this embodiment is an example of an “electric motor” according to an aspect of the present invention.

The motor generator MG2 has a stator 60 secured to the transaxle case 80 described later and a rotatable rotor 61. The stator 60 has a stator core 62 and a coil 63 wound around the stator core 62. The rotor 61 and the stator core 62 are formed by laminating a plurality of magnetic steel sheets, respectively having predetermined thicknesses, in a thickness direction thereof. Note that the plurality of magnetic steel sheets are laminated in the shaft direction. A rotor shaft 14 is arranged in the center of the rotor 61, and the rotor 61 and the rotor shaft 14 are connected. The rotor shaft 14 is supported by bearings 64 and 65. An output gear 66 is attached to an end section of the rotor shaft 14. Accordingly, the rotor 61, the rotor shaft 14, and the output gear 66 rotate integrally. Note that the output gear 66 meshes with the counter gear 25. The bearings 64 and 65 supporting the rotor shaft 14 are arranged in a space outside the rotor 61. Accordingly, reduction in the size of the motor generator MG2 in a radial direction thereof is achieved. Note that the rotor shaft 14 of this embodiment is an example of a “rotation shaft of the electric motor” according to an aspect of the present invention, the bearings 64 and 65 is an example of a “electric motor bearings” according to an aspect of the present invention, and the bearing 64 is an example of “gear side bearing” according to an aspect of the present invention.

Since the motor generator MG2 is arranged on the separate axis parallel to the input shaft on the opposite side of the motor generator MG1 with respect to the counter gear 25 in the shaft direction in this manner, the rotation of the motor generator MG2 is reduced by the counter gear 25 and the output gear 66. Therefore, since a large reduction ratio can be set, high performance is not required for the motor generator MG2, whereby reduction in the size and cost of the motor generator MG2 is achieved. Since the bearings 64 and 65 of the motor generator MG2 are arranged outside of the motor generator MG2, a reduction in the size of the motor generator MG2 in the radial direction is further achieved.

A counter shaft 15 is provided on a separate axis parallel to the input shaft 11. The counter shaft 15 is formed with a counter driven gear 70 and a final drive pinion gear 71. The counter driven gear 70 meshes with the counter gear 25, and the final drive pinion gear 71 meshes with a final ring gear 44 of the differential device 40.

The differential device 40 has a plurality of pinion gears 42, a side gear 43 which meshes with the plurality of pinion gears 42, and the final ring gear 44 joined with the plurality of pinion gears 42. The drive shaft 12 connected to the drive wheel is connected to the side gear 43.

The respective component parts of the drive device arranged as described above are stored and secured in the hollow transaxle case 80, as shown in FIG. 2. The transaxle case 80 is attached to an outer wall of the engine. The transaxle case 80 has an engine side housing 81, an extension housing 82, and an end cover 83. The engine side housing 81, the extension housing 82, and the end cover 83 are formed by a molding process using a metal material such as aluminum.

In the transaxle case 80, the engine side housing 81, the extension housing 82, and the end cover 83 are arranged in that order from the engine side. The outer wall of the engine and the engine side housing 81 are secured to each other in a state where one opening end 84 of the engine side housing 81 and the outer wall of the engine are in contact. The engine side housing 81 and the extension housing 82 are secured to each other in a state where the other opening end 85 of the engine side housing 81 and one opening end 86 of the extension housing 82 are in contact. Further, the end cover 83 is attached so as to close the other opening end 87 of the extension housing 82, whereby the end cover 83 and the extension housing 82 are secured to each other.

The motor generator MG1 is stored in and supported by the engine side housing 81, and the motor generator MG2 is stored in and supported by the extension housing 82. That is, the engine side housing 81 also serves as a case of the motor generator MG1, and the extension housing 82 also serves as a case of the motor generator MG2. In this manner, the drive device according to this embodiment is formed as a so-called transaxle in which the differential gear device 20 and the differential device 40 are embedded together in the transaxle case 80.

Next, arrangements and configurations of respective parts in the vicinity of the oil pump 30 as one feature of the present invention will be described in detail with reference to FIG. 3. As shown in FIG. 3, the oil pump 30 has an oil pump gear mechanism 31 arranged inside an oil pump gear chamber 32, an oil pump cover 33 which closes an opening of the oil pump gear chamber 32, and the oil pump shaft 35 of which an end section is secured to the oil pump gear mechanism 31.

The oil pump gear chamber 32 is formed inside a first extended section 82a which is a part of the extension housing 82 extended in the shaft direction toward the counter gear 25. Therefore, the oil pump gear chamber 32 is open on the counter gear 25 side. The oil pump cover 33 which closes the opening of the oil pump gear chamber 32 is secured to the extension housing 82 by a taper snap ring 34 at a radial direction end section. Accordingly, a casing of the oil pump 30 is formed by the first extended section 82a and the oil pump cover 33. Note that the first extended section 82a extends up to a vicinity of a ring gear shaft 16 and an end section of a boss section 17 of the counter gear 25 so as to encompass the circumference of the oil pump gear mechanism 31.

By forming the oil pump 30 in this manner, the motor generator MG2 and the oil pump 30 can be arranged close to each other in the shaft direction. Since the oil pump cover 33 is secured by the taper snap ring 34, a bolt is not used to secure the oil pump cover as in the drive device of the related art. Thus, it is not necessary to ensure arrangement space for a bolt head, whereby the oil pump 30 and the counter gear 25 can be arranged close to each other in the shaft direction. Further, since the oil pump gear chamber 32 is formed integrally with the extension housing 82, the number of parts is reduced.

The oil pump 30 is arranged to overlap with the motor generator MG2 in the radial direction and to overlap with the bearing 64 of the motor generator MG2 in the shaft direction. Therefore, even though the bearings 64 and 65 of the motor generator MG2 are arranged outside the motor generator MG2, the shaft direction length of the drive device is not influenced.

The extension housing 82 is formed with a second extended section 82b continuous with the first extended section 82a. The second extended section 82b is formed to extend almost up to a wheel surface 25a of the counter gear 25 so as to encompass the boss section 17 of the counter gear 25. A bearing 26 supporting the counter gear 25 is held by an inner circumference surface 82c of the second extended section 82b. Note that the bearing 26 is a bearing such as an angular contact bearing which restricts movements in the shaft direction and the radial direction. With such configuration, the oil pump 30 and the counter gear 25 can be arranged close to each other in the shaft direction. Since a holding section of the bearing 26 is formed integrally with the extension housing 82, the number of parts is reduced.

A system of power transmission to the oil pump shaft 35 will now be described. The power transmission system is formed by the input shaft 11, the ring gear shaft 16, the counter gear 25, and the one-way clutches 90 and 91. The power transmission system is arranged collectively on the inner circumference side of the boss section 17 of the counter gear 25.

Specifically, the input shaft 11 penetrates the differential gear device 20 to protrude on the inner circumference side of the boss section 17, and a protrusion section 11a is formed in the protruding portion. The input shaft 11 is connected to the one-way clutch 90 at the inner circumference surface of the protrusion section 11a. The ring gear shaft 16 which is the rotation shaft of the ring gear 22 is inserted to the inner circumference side of the boss section 17. The ring gear shaft 16 is connected to the counter gear 25 on the outer circumference surface, and is connected to the one-way clutch 91 on the inner circumference surface. The oil pump shaft 35 is inserted to fit the respective inner circumference surfaces of the one-way clutches 90 and 91 connected to the input shaft 11 and the ring gear shaft 16 in this manner. With such a simple configuration, the oil pump shaft 35 can be drive-connected to the input shaft 11 via the one-way clutch 90, and be drive-connected to the ring gear shaft 16, which is connected with the counter gear 25, via the one-way clutch 91.

The one-way clutches 90 and 91 are adjacent to each other in the shaft direction, and are arranged to overlap with the bearing 26 in the shaft direction. Accordingly, increase in the size of the bearing 26 in the radial direction and increase in the size of the drive device in the shaft direction caused by providing the one-way clutches 90 and 91 are prevented.

With the power transmission system, power is transmitted from one of the input shaft 11 and the counter gear 25 to the oil pump shaft 35 in the oil pump 30, whereby the oil pump gear mechanism 31 is operated by the power to pump out oil in the oil pump gear chamber 32. Note that the oil pumped from the oil pump 30 is supplied to component parts such as the differential gear device 20 via an oil path formed in the input shaft 11.

Arrangement relations among respective parts included in the drive device according to the first embodiment will now be described with reference to FIG. 4. In FIG. 4, the side on which the input shaft 11 is arranged is a vehicle front side, and the side on which the drive shaft 12 is arranged is a vehicle rear side. As shown in FIG. 4, the rotor shaft 14 of the motor generator MG2 is arranged on the rear side compared to the input shaft 11, the counter shaft 15 is arranged on the rear side compared to the rotor shaft 14, and the drive shaft 12 is arranged on the rear side compared to the counter shaft 15. The rotor shaft 14 is arranged on the upper side compared to the input shaft 11, and the counter shaft 15 and the drive shaft 12 are arranged on the lower side compared to the input shaft 11. Note that the counter shaft 15 is arranged on the lower side compared to the drive shaft 12. That is, the rotor shaft 14 is arranged to be located between the input shaft 11 and the drive shaft 12 and on the upper side compared to the input shaft 11. With such shaft arrangements, the motor generator MG2 provided on the separate axis from that of the input shaft 11 can be arranged in a space existing between the input shaft 11 and the drive shaft 12, whereby reduction in the size of the drive device in the radial direction can be achieved and the minimum ground clearance of the vehicle can be prevented from being lowered.

The drive device having the configuration described above is controlled by an electronic control device which controls the entire vehicle. That is, a signal of an ignition switch, a signal of an engine rotational speed sensor, a signal of a brake switch, a signal of a vehicle speed sensor, a signal of an accelerator opening angle sensor, a signal of a shift position sensor, a signal of a resolver which detects respective rotational speeds of the motor generators MG1 and MG2, and the like are input to the electronic control device. Accordingly, a request torque to be transmitted to the drive shaft (drive wheel) 12 is calculated by the electronic control device based on the signals. Based on a calculation result, a signal which controls an intake air amount and a fuel injection amount of the engine and an ignition timing, a signal which controls outputs of the motor generators MG1 MG2, and the like are output by the electronic control device to respective parts, whereby an overall operation of the drive device is controlled.

More specifically, in the case where the power (torque) output from the engine is transmitted to the drive shaft (drive wheel) 12, the torque of the engine is transmitted to the planetary carrier 24 via the input shaft 11. The torque transmitted to the planetary carrier 24 is transmitted to the drive shaft 12 via the ring gear 22, the counter gear 25, the counter driven gear 70, the counter shaft 15, the final drive pinion gear 71, and the differential device 40, whereby driving force is generated. In this case, the drive shaft 12 is driven only by the power of the engine.

When the torque of the engine is transmitted to the planetary carrier 24, the motor generator MG1 functions as the electric generator, whereby electric power generated by the motor generator MG1 is charged in an electric storage device (not shown).

On the other hand, in the case where the motor generator MG2 is driven as the electric motor to transmit the power thereof to the drive shaft 12, the power (torque) of the motor generator MG2 is transmitted to the output gear 66 via the rotor shaft 14, and the rotation of the output gear 66 is reduced and transmitted to the counter gear 25. The torque of the motor configuration MG2 is combined with the torque of the engine at the counter gear 25, and the combined torque is transmitted to the drive shaft 12 via the counter driven gear 70, the counter shaft 15, the final drive pinion gear 71, and the differential device 40, whereby a driving force is generated. In this case, the drive shaft 12 is driven by the power of the engine assisted by the power of the motor generator MG2 or by the power of the motor generator MG2 alone.

In the case where the drive shaft 12 is driven by the power of the engine alone or by the power of the engine assisted by the power of the motor generator MG2, the input shaft 11 and the ring gear shaft 16 both rotate in a predetermined direction. Depending on the driving (running) state of the vehicle, there are cases where the rotational speed of the ring gear shaft 16 is higher than the rotational speed of the input shaft 11 connected to the planetary carrier 24, and there are cases where the rotational speed of the ring gear shaft 16 is lower than the rotational speed of the input shaft 11.

In the case where the rotational speed of the ring gear shaft 16 is higher than the rotational speed of the input shaft 11, the one-way clutch 91 comes into a locked state and the one-way clutch 90 comes into a free state. As a result, the rotation of the ring gear shaft 16, i.e., the rotation of the counter gear 25, is transmitted to the oil pump shaft 35 via the one-way clutch 91, whereby the oil pump 30 is driven.

On the other hand, in the case where the rotational speed of the ring gear shaft 16 is lower than the rotational speed of the input shaft 11, the one-way clutch 90 comes into a locked state and the one-way clutch 91 comes into a free state. As a result, the rotation of the input shaft 11 is transmitted to the oil pump shaft 35 via the one-way clutch 90, whereby the oil pump 30 is driven.

On the other hand, in the case where the drive shaft 12 is driven by the power of the motor generator MG2 alone, the operation of the engine is stopped, whereby the input shaft 11 does not rotate. However, the rotation of the rotor shaft 14 of the motor generator MG2 is transmitted to the counter gear 25 via the output gear 66. Therefore, the ring gear shaft 16 connected to the counter gear 25 rotates in a predetermined direction. Thus, in this case, the rotational speed of the ring gear shaft 16 is higher than the rotational speed of the input shaft 11, whereby the one-way clutch 91 comes into the locked state and the one-way clutch 90 comes into the free state. As a result, the rotation of the ring gear shaft 16, i.e., the rotation of the counter gear 25, is transmitted to the oil pump shaft 35 via the one-way clutch 91, whereby the oil pump 30 is driven.

In the case where the engine is operated to operate the motor generator MG1 as the electric generator in a state where the vehicle is stopped, the counter gear 25 drive-connected to the drive shaft 12 (and the ring gear shaft 16 connected to the counter gear 25) is not rotated, but the input shaft 11 is rotated. Thus, the rotational speed of the input shaft 11 is higher than the rotational speed of the ring gear shaft 16, whereby the one-way clutch 90 comes into the locked state and the one-way clutch 91 comes into the free state. As a result, the rotation of the input shaft 11 is transmitted to the oil pump shaft 35 via the one-way clutch 90, whereby the oil pump 30 is driven.

Note that, in a state where the vehicle is stopped and the engine is not operated, i.e., in a state where the vehicle is stopped in a mode for running by the power of the motor generator MG2 alone, the input shaft 11 and the ring gear shaft 16 both do not rotate, whereby the oil pump shaft 35 does not rotate.

In this manner, in the drive device according to the first embodiment, the oil pump shaft 35 is driven by one of the input shaft 11 and the counter gear 25 having greater rotational speed, whereby the oil pump 30 is driven to generate hydraulic pressure as long as one of the input shaft 11 and the counter gear 25 is rotated, i.e., the engine is operated, or the vehicle is moving forward.

Since the one-way clutches 90 and 91 are arranged outside the oil pump 30, the shaft direction length of the oil pump 30 does not increase. Since the oil pump 30 does not increase in size, the pump loss does not increase, whereby the performance of the oil pump 30 does not decrease. Further, since the one-way clutches 90 and 91 are arranged adjacent to each other in the shaft direction so as to overlap with the bearing 26 of the counter gear 25 in the shaft direction, the bearing 26 does not increase in the radial direction, whereby providing the one-way clutches 90 and 91 does not influence the shaft direction length of the drive device. Thus, the shaft direction length can be shortened to achieve a reduction in the size of the drive device as a whole.

The differential gear device 20, the counter gear 25, and the oil pump 30 are arranged coaxially with the input shaft 11 to be adjacent with each other in that order from the engine side, and the input shaft 11 is provided such that the protrusion section 11a thereof is located on the inner circumference side of the boss section 17 of the counter gear 25. Accordingly, the oil pump 30 and the one-way clutches 90 and 91 can be proximately arranged, whereby the shaft direction length of the drive device can further be shortened to achieve a reduction in size and the assembly of the drive device can be improved.

Further, the motor generator MG2 is arranged on the separate axis parallel to the input shaft 11 on the opposite side of the motor generator MG1 with respect to the counter gear 25 in the shaft direction, the bearings 64 and 65 supporting the rotor shaft 14 of the motor generator MG2 are arranged outside the motor generator MG2, and the oil pump 30 is arranged to overlap with the motor generator MG2 in the radial direction and to overlap with the bearing 64 in the shaft direction. Accordingly, the oil pump 30 and the one-way clutches 90 and 91 can further be proximately arranged, whereby the shaft direction length of the drive device can further be shortened to achieve a reduction in size and the assembly of the drive device can be improved.

As described above in detail, in the drive device according to the first embodiment, the oil pump shaft 35 is drive-connected to the input shaft 11 via the one-way clutch 90 and drive-connected to the counter gear 25 via the one-way clutch 91, and the one-way clutches 90 and 91 are arranged on the inner circumference side of the boss section 17 of the counter gear 25 so as to overlap with the bearing 26 supporting the counter gear 25 in the shaft direction, whereby the oil pump 30 can be driven by rotational power of one of the input shaft 11 and the counter gear 25 and the shaft direction length of the drive device can be shortened to achieve a reduction in size without causing the performance of the oil pump 30 to decrease.

### Second embodiment

Next, a second embodiment of the present invention will be described. In a drive device according to the second embodiment, arrangement positions of the motor generator MG2 and the oil pump 30 differ from those of the first embodiment. Therefore, in the description below, differences from the first embodiment will mainly be described. Common parts will be denoted by the same reference numerals in the drawings, and descriptions thereof will appropriately be omitted.

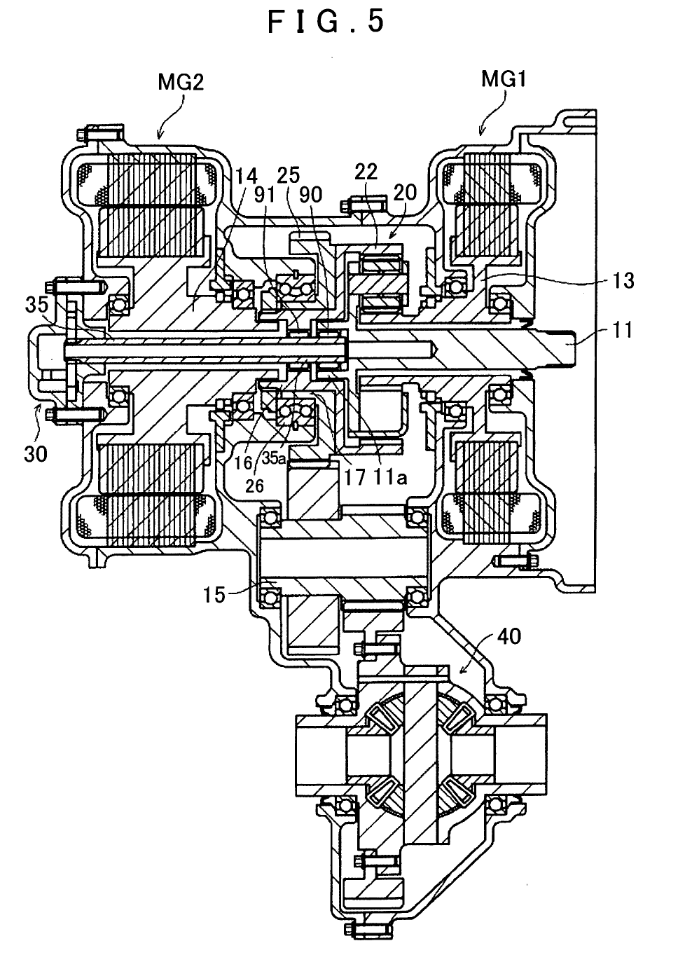

The drive device according to the second embodiment will be described with reference to FIG. 5. FIG. 5 is a sectional view showing a schematic configuration of the drive device according to the second embodiment. As shown in FIG. 5, in the drive device according to the second embodiment, the motor generator MG2 is arranged coaxially with the input shaft 11 so as to be adjacent to the counter gear 25. The rotor shaft 14 of the motor generator MG2 is connected to the ring gear shaft 16. Therefore, unlike the first embodiment, the rotation of the motor generator MG2 is transmitted to the counter gear 25 via the ring gear 22 without being reduced.

The oil pump 30 is arranged coaxially with the input shaft 11 so as to be adjacent to the motor generator MG2 on the opposite side of the counter gear 25. The oil pump shaft 35 of the oil pump 30 is arranged inside the rotor shaft 14, and an end section 35a thereof protrudes from the rotor shaft 14. The end section 35a of the oil pump shaft 35 is inserted to fit the inner circumference surfaces of the one-way clutches 90 and 91. With such configuration, the oil pump shaft 35 can be drive-connected to the input shaft 11 via the one-way clutch 90, and be drive-connected to the ring gear shaft 16, which is connected with the counter gear 25, via the one-way clutch 91 in the second embodiment as well.

Since the one-way clutches 90 and 91 are arranged outside the oil pump 30 in the same manner as those of the first embodiment, the shaft direction length of the oil pump 30 can be shortened compared to that of the related art (having a built-in one-way clutch). Since the oil pump 30 does not increase in size, the pump loss associated with an increase in oil amount does not increase, whereby the performance of the oil pump 30 does not decrease. Further, since the one-way clutches 90 and 91 are arranged in an inner circumference section of the boss section 17 of the counter gear 25 so as to be adjacent to each other in the shaft direction, whereby providing the one-way clutches 90 and 91 does not influence the shaft direction length of the drive device and the bearing 26 does not increase in the radial direction.

In this manner, the oil pump 30 can be driven by rotational power of one of the input shaft 11 and the counter gear 25 and the shaft direction length of the drive device can be shortened to achieve a reduction in size without causing the performance of the oil pump 30 to decrease, also with the drive device according to the second embodiment in which the motor generator MG2 is arranged coaxially with the input shaft 11.

Note that the embodiments described above merely show examples, and do not in any way limit the present invention. It is needless to say that various modifications and variations are possible without departing from the spirit and scope of the present invention. For example, in the embodiments described above, the present invention is applied to the transverse-type drive device mounted to a car having the front-engine front-wheel drive (FF) layout as an example, but the present invention may also be applied to a transverse-type drive device mounted to a car having rear-engine rear-wheel drive (RR) layout.

According to various exemplary aspects of the invention, the oil pump shaft connected to the oil pump gear mechanism for generating hydraulic pressure is drive-connected to the input shaft via the first one-way clutch and is drive-connected to the counter gear via the second one-way clutch. Therefore, one of the input shaft and the counter gear having a greater rotational speed is drive-connected to the oil pump shaft by the first and second one-way clutches, while one having a slower rotational speed comes into a free state. Thus, the oil pump shaft is driven by one of the input shaft (input side rotation shaft) and the counter gear (output side rotation shaft) having a greater rotational speed. Accordingly, the oil pump shaft is driven by one of the input shaft and the counter gear, whereby the oil pump gear mechanism is operated to generate hydraulic pressure. In this manner, hydraulic pressure can be generated since the oil pump is driven as long as one of the input shaft and the counter gear is rotated, i.e., the engine is operated, or the vehicle is moving forward.

In the hybrid vehicle drive device, the first and second one-way clutches are arranged on the inner circumference side of the bearing of the counter gear having less structural limitations. That is, the first and second one-way clutches are arranged outside the oil pump. Therefore, the shaft direction length of the oil pump does not increase. At least one of the first and second one-way clutches is arranged to overlap with the bearing of the counter gear in the shaft direction. Therefore, providing the first and second one-way clutches does not influence the shaft direction length of the drive device. Thus, the shaft direction length can be shortened to achieve a reduction in the size of the drive device as a whole. Since the oil pump does not increase in size, the pump loss does not increase, whereby the performance of the oil pump does not decrease.

In this manner, with the hybrid vehicle drive device, the oil pump can be operated by rotational power from one of the input shaft and the counter gear and the shaft direction length of the drive device can be shortened to achieve a reduction in size without causing the performance of the oil pump to decrease.

According to an exemplary aspect of the invention, the bearing of the counter gear can be prevented from lengthening in a radial direction. Therefore, a similar bearing to that of the related art can be used, whereby it is unnecessary to provide a new arrangement space. Thus, by arranging the first and second one-way clutches to be adjacent to each other in the shaft direction, the oil pump can be driven by rotational power transmitted from one of the input shaft and the counter gear having greater rotational speed by changing the shape or configuration of parts arranged inside the bearing of the counter gear. Since the shape or configuration of the parts arranged inside the bearing of the counter gear is changed, the drive device does not increase in size.

According to an exemplary aspect of the invention, the oil pump shaft and the counter gear can be drive-connected via the second one-way clutch on the inner circumference side of the boss section of the counter gear.

According to an exemplary aspect of the invention, the oil pump shaft and the input shaft can be drive-connected via the first one-way clutch on the inner circumference side of the boss section of the counter gear.

According to an exemplary aspect of the invention, by providing the input shaft to penetrate the differential gear device and arranging the differential gear device, the counter gear, and the oil pump coaxially with the input shaft to be adjacent to each other in that order from the engine side, the oil pump and the one-way clutch can be proximately arranged. Therefore, the shaft direction length of the drive device can further be shortened to achieve a reduction in size, and the assembly of the drive device can be improved.

Note that the oil pump overlapping with the electric motor in the radial direction or overlapping with the gear side bearing of the electric motor in the shaft direction refers to a state where at least a part of the component parts of the oil pump (for example, the oil pump gear mechanism or the oil pump cover) overlaps with the electric motor in the radial direction or overlaps with the gear side bearing in the shaft direction.

According to an exemplary aspect of the invention, the oil pump and the one-way clutch can be proximately arranged. Therefore, the shaft direction length of the drive device can further be shortened to achieve a reduction in size, and assembly of the drive device can be improved. The rotation of the electric motor can be reduced by using the counter gear (by transmitting the rotation of the electric motor to the counter gear via a gear smaller than the counter gear). Accordingly, since a reduction ratio can be increased, high performance of the electric motor is not required, whereby the electric motor can be reduced in size and cost.

With the hybrid vehicle drive device according to some exemplary aspects of the present invention, as described above, the oil pump can be operated with power from one of the two rotation shafts and the shaft direction length of the drive device can be shortened to achieve a reduction in size without causing the performance of the oil pump to decrease.

What is claimed is:

1. A hybrid vehicle drive device comprising:
an input shaft to which power from an engine is input;
an electric generator;
an electric motor;
a counter gear that transmits power to a drive shaft;
a differential gear device that includes a first gear component connected to a rotation shaft of the electric generator, a second gear component connected to the input shaft, and a third gear component connected to the counter gear; and
an oil pump that generates hydraulic pressure; wherein
the oil pump includes an oil pump gear mechanism that generates hydraulic pressure and an oil pump shaft connected to the oil pump gear mechanism;
the oil pump shaft is drive-connected to the input shaft via a first one-way clutch and is drive-connected to the counter gear via a second one-way clutch; and
the first and second one-way clutches are arranged on an inner circumference side of a bearing of the counter gear such that at least one of the first and second one-way clutches overlaps with the bearing of the counter gear in a shaft direction.

2. The hybrid vehicle drive device according to claim 1, wherein the first and second one-way clutches are arranged adjacent to each other in the shaft direction.

3. The hybrid vehicle drive device according to claim 2, wherein a rotation shaft of the third gear component is inserted to an inner circumference side of a boss section of the counter gear, connected to the counter gear at an outer circumference surface thereof, and connected to the second one-way clutch at an inner circumference surface.

4. The hybrid vehicle drive device according to claim 3, wherein the input shaft includes a protrusion section protruding on the inner circumference side of the boss section of the counter gear, and is connected to the first one-way clutch at the protrusion section thereof.

5. The hybrid vehicle drive device according to claim 4, wherein:
the differential gear device, the counter gear, and the oil pump are arranged coaxially with the input shaft to be adjacent to each other in that order from an engine side; and
the input shaft is provided to penetrate the differential gear device such that the protrusion section is located on the inner circumference side of the boss section of the counter gear.

6. The hybrid vehicle drive device according to claim 5, wherein:
the electric motor is arranged on a separate axis parallel to the input shaft on an opposite side of the electric generator with respect to the counter gear;
an electric motor bearing rotatably supporting a rotation shaft of the electric motor is arranged outside the electric motor; and
the oil pump is arranged to overlap with the electric motor in a radial direction and to overlap with a gear side bearing, which is the electric motor bearing located on a side of the counter gear, in the shaft direction.

7. The hybrid vehicle drive device according to claim 2, wherein the input shaft includes a protrusion section protruding on an inner circumference side of a boss section of the counter gear, and is connected to the first one-way clutch at the protrusion section thereof.

8. The hybrid vehicle drive device according to claim 7, wherein:
the differential gear device, the counter gear, and the oil pump are arranged coaxially with the input shaft to be adjacent to each other in that order from an engine side; and
the input shaft is provided to penetrate the differential gear device such that the protrusion section is located on the inner circumference side of the boss section of the counter gear.

9. The hybrid vehicle drive device according to claim 8, wherein:
the electric motor is arranged on a separate axis parallel to the input shaft on an opposite side of the electric generator with respect to the counter gear;
an electric motor bearing rotatably supporting a rotation shaft of the electric motor is arranged outside the electric motor; and
the oil pump is arranged to overlap with the electric motor in a radial direction and to overlap with a gear side bearing, which is the electric motor bearing located on a side of the counter gear, in the shaft direction.

10. The hybrid vehicle drive device according to claim 1, wherein a rotation shaft of the third gear component is inserted to an inner circumference side of a boss section of the counter gear, connected to the counter gear at an outer circumference surface thereof, and connected to the second one-way clutch at an inner circumference surface.

11. The hybrid vehicle drive device according to claim 10, wherein the input shaft includes a protrusion section protruding on the inner circumference side of the boss section of the counter gear, and is connected to the first one-way clutch at the protrusion section thereof.

12. The hybrid vehicle drive device according to claim 11, wherein:
the differential gear device, the counter gear, and the oil pump are arranged coaxially with the input shaft to be adjacent to each other in that order from an engine side; and
the input shaft is provided to penetrate the differential gear device such that the protrusion section is located on the inner circumference side of the boss section of the counter gear.

13. The hybrid vehicle drive device according to claim 12, wherein:
the electric motor is arranged on a separate axis parallel to the input shaft on an opposite side of the electric generator with respect to the counter gear;
an electric motor bearing rotatably supporting a rotation shaft of the electric motor is arranged outside the electric motor; and
the oil pump is arranged to overlap with the electric motor in a radial direction and to overlap with a gear side bearing, which is the electric motor bearing located on a side of the counter gear, in the shaft direction.

14. The hybrid vehicle drive device according to claim 1, wherein:
the electric motor is arranged on a separate axis parallel to the input shaft on an opposite side of the electric generator with respect to the counter gear;
an electric motor bearing rotatably supporting a rotation shaft of the electric motor is arranged outside the electric motor; and
the oil pump is arranged to overlap with the electric motor in a radial direction and to overlap with a gear side bearing, which is the electric motor bearing located on a side of the counter gear, in the shaft direction.

15. The hybrid vehicle drive device according to claim 1, wherein:
the oil pump includes an oil pump cover that close an opening of an oil pump gear chamber that is open at a counter gear side; and
the oil pump cover is secured to a housing that serves as a case for the electric motor by a snap ring at a radial direction end section.

16. The hybrid vehicle drive device according to claim 15, wherein the oil pump gear chamber is formed integrally with the housing.

17. The hybrid vehicle drive device according to claim 1, wherein a rotation shaft of the electric motor is arranged between the input shaft and the drive shaft and on an upper side compared to the input shaft.

18. The hybrid vehicle drive device according to claim 1, wherein the first and second one-way clutches are arranged outside of the oil pump.

19. The hybrid vehicle drive device according to claim 1, wherein both of the first and second one-way clutches overlaps with the bearing of the counter gear in the shaft direction.

20. The hybrid vehicle drive device according to claim 1, wherein:
the oil pump shaft is drive connected to the input shaft via the first one-way clutch when a rotation speed of the input shaft is greater than a rotation speed of the counter gear; and
the oil pump shaft is drive connected to the input shaft via the second one-way clutch when the rotation speed of the counter gear is greater than the rotation speed of the input shaft.
